(19) United States
(12) Patent Application Publication
(10) Pub. No.: US 2006/0254870 A1
(43) Pub. Date: Nov. 16, 2006

(54) Magneto-rheological coupling with sealing provisions

(76) Inventors: Balarama V. Murty, West Bloomfield, MI (US); Chandra S. Namuduri, Troy, MI (US); Jie Tong, Rowland Heights, CA (US); Kenneth J. Shoemaker, Highland, MI (US)

Correspondence Address: KATHRYN A MARRA;General Motors Corporation, Mail Code 482-C23-B21, P.O. Box 300, Detroit, MI, 48265-3000, US

(21) Appl. No.: 11/246,029

(22) Filed: Oct. 7, 2005

Related U.S. Application Data
(60) Provisional application No. 60/680,194, filed on May 12, 2005.

(51) Int. Cl. F16D 27/00

(52) U.S. Cl. 192/21.5

(57) ABSTRACT

A magneto-rheological coupling (MRC) is provided having an input assembly operable to receive a torque input and an output member operable to selectively transmit torque to a driveshaft. A magneto-rheological fluid, or MRF, having a variable viscosity in response to a magnetic flux field is operable to vary the torque transmitted from the input assembly to the output member. At least one annular lip forming a magneto-rheological fluid retention pocket is provided on at least one of the input assembly and the output member of the MRC. The annular lip is operable to direct MRF away from a roller bearing, thereby reducing the likelihood of MRF fluid incursion within the roller bearing. Additionally, a labyrinth seal may be employed to provide additional protection to the bearing. The labyrinth seal may have an annular bushing disposed therein to reduce the clearances of the labyrinth seal.

### CROSS-REFERENCE TO RELATED APPLICATIONS

This application claims the benefit of U.S. Provisional Application 60/680,194, filed May 12, 2005, and which is hereby incorporated by reference in its entirety.

### TECHNICAL FIELD

The present invention relates to magneto-rheological couplings.

### BACKGROUND OF THE INVENTION

It is known to provide a power steering system for a vehicle such as a motor vehicle to assist a driver in steering the motor vehicle. Typically, the power steering system is of a hydraulic type. The hydraulic power steering system employs an engine driven hydraulic power steering pump for generating pressurized fluid, which is subsequently communicated to a hydraulic steering gear of the motor vehicle. Since the power steering pump is driven directly by the engine using a belt or other method, its rotational speed is determined by that of the engine and it operates continuously as long as the engine is running, resulting in continuous circulation of the hydraulic fluid through the steering gear. In addition, the power steering pump must provide the required flow and pressure for the worst case engine speed, which is typically near idle engine speed, under static steering conditions.

More recently, electro-hydraulic power steering systems have been used to provide an on-demand hydraulic pressure using an electric motor to drive the hydraulic power steering pump. An example of such an electro-hydraulic power steering system incorporates a hydraulic power steering pump driven by a brushless direct current electric motor controlled by a pulse width modulated inverter. Also in use are electrically driven steering systems, which are operable to assist in steering the vehicle using purely electro-mechanical system components.

Other devices, such as the one described in commonly assigned U.S. Pat. No. 6,920,753, provide a means to directly control the speed of the power steering pump by using a magneto-rheological clutch or coupling (MRC) disposed between the accessory drive belt and the power steering pump. The MRC provides a continuously variable speed by controlling the torque transmitted to the power steering pump. The MRC can be part of the pump assembly, a separate unit, an integral part of the pump pulley, etc. The viscosity of the magneto-rheological fluid, or MRF, contained within the MRC can be controlled by exposing the MRF to a magnetic flux field. As the viscosity of the MRF is increased, the torque transfer properties of the fluid are increased. Since a conventional electronic control unit (ECU) can control the intensity of the magnetic field, the duty cycle of the power steering pump may be varied independent of engine speed.

The MRF contained within the MRC includes magnetically permeable particles, which tend to be highly abrasive and harmful to bearings. Although bearings within the MRC are typically sealed units, it is preferred that the MRF fluid should not be allowed to contact these seals.

### SUMMARY OF THE INVENTION

Accordingly, the present invention provides a magneto-rheological clutch or coupling (MRC) having improved sealing provisions such that the magneto-rheological fluid, or MRF, is substantially precluded from contacting bearings within the MRC.

A magneto-rheological coupling, or MRC, is provided having an input assembly coaxially disposed and spaced from an output member such that a working gap is defined between the input assembly and the output member. A magneto-rheological fluid is at least partially disposed within the working gap. The magneto-rheological fluid exhibits a variable viscosity characteristic in the presence of a variable magnetic field. Also provided is at least one bearing operable to rotatably mount the input assembly with respect to the output member. Additionally, at least one annular lip is provided with respect to at least one of the input assembly and the output member. The annular lip is operable to direct the flow of the magneto-rheological fluid away from the bearing.

At least one labyrinth seal may be provided that is operable to substantially restrict the flow of the magneto-rheological fluid from contacting the bearing. Additionally, an annular bushing may be disposed within the labyrinth seal. The annular bushing is operable to reduce the clearances of the at least one labyrinth seal by providing a predetermined amount of sacrificial material which is removed through wear during the operation of the MRC.

The above features and advantages and other features and advantages of the present invention are readily apparent from the following detailed description of the best modes for carrying out the invention when taken in connection with the accompanying drawings.

### BRIEF DESCRIPTION OF THE DRAWING

FIG. 1 is a cross sectional side elevational view of a magneto-rheological fluid clutch or coupling (MRC) of the present invention, shown at rest and adapted to operate a vehicular power steering pump.

### DESCRIPTION OF THE PREFERRED EMBODIMENT

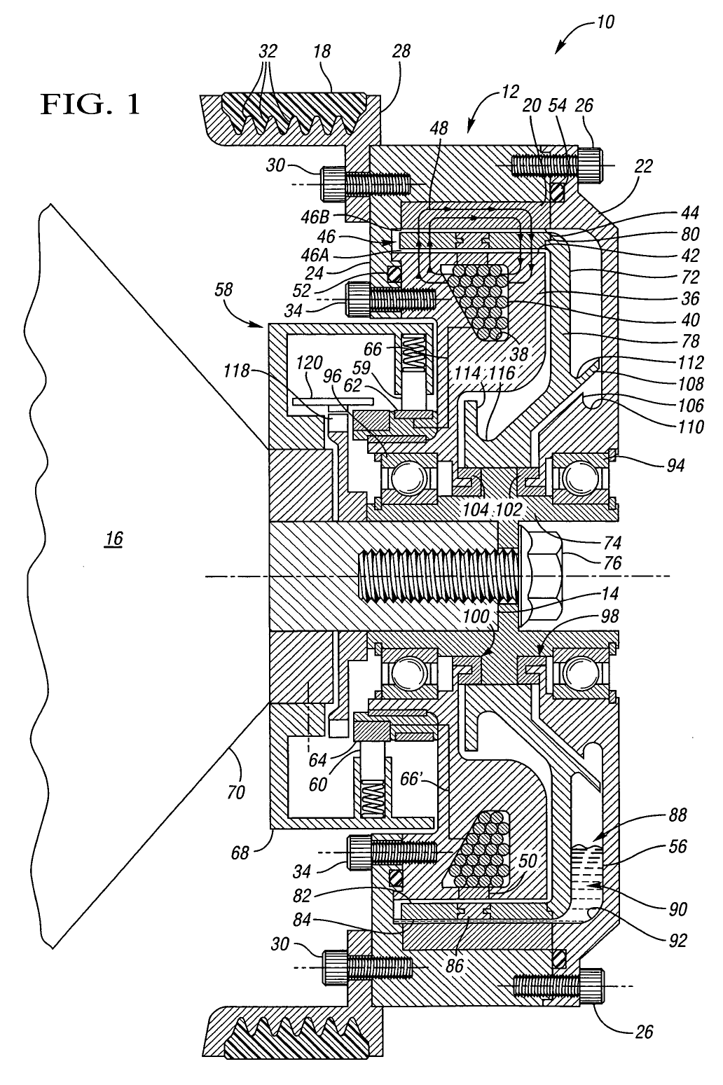

Referring now to FIG. 1, there is shown a magneto-rheological fluid clutch or coupling (MRC), generally indicated at 10, having an input assembly 12 rotatably mounted with respect to a drive shaft 14 of a hydraulic power steering pump 16 and adapted to be driven by an engine accessory drive belt 18. Those skilled in the art will recognize additional methods of providing drive to the input assembly 12, such as a gear drive. The MRC 10 is adapted to provide variable rotational speed to the drive shaft 14 of the power steering pump 16. The rotational speed of the drive shaft 14 may be varied from a zero rotational speed condition to a maximum of the rotational speed of the input assembly 12. The input assembly 12 includes a generally cylindrical magnetically permeable ring 20 coaxially located with respect to, and radially spaced from, the drive shaft 14. Secured to the magnetically permeable ring 20 is a non-magnetic first cover member 22 that extends radially inward toward a central axis of the driveshaft 14. The magnetically permeable ring 20 pilots a non-magnetic second cover member 24, having a generally L-shaped partial cross section, to the first cover member 22. The axially extending portion of the second cover member 24 is secured to the first cover member 22 via a plurality of fasteners 26. A pulley member 28 is secured to the second cover member 24 via a plurality of fasteners 30. The outer circumferential surface of the pulley member 28 has a plurality of radially extending ribs 32 defined thereon. The ribs 32 are operable to provide a surface upon which the accessory drive belt 18 may frictionally engage.

The second cover member 24 is secured, via a plurality of fasteners 34, to a magnetically permeable core 36 disposed coaxially with respect to, and spaced from, the drive shaft 14. The core 36 has an annular channel 38 with a wire coil 40 disposed therein. An outer surface 42 of the core 36 forms an inner boundary, while an inner surface 44 of the magnetically permeable ring 20 forms an outer boundary of a working gap 46. The wire coil 40 is operable to provide a magnetic flux field 48 when energized with electrical current. The core 36 has a low magnetically permeable portion 50 formed centrally thereon. The portion 50 is filled with a high-temperature resistant epoxy or other suitable non-magnetic material, and operates to shape the magnetic flux field 48 of the core 36 and ensures proper distribution through the working gap 46. Additionally, the interstices of the wire coil 40 within the channel 38 may be filled with a high-temperature resistant epoxy similar to that of the portion 50. A seal 52, such as an elastomeric o-ring, is disposed between the second cover member 24 and the core 36. Likewise, a seal 54, such as an elastomeric o-ring, is disposed between the second cover member 24 and the first cover member 22. The seals 52 and 54 operate to prevent leakage of magneto-rheological fluid (MRF) 56 from the MRC 10.

The MRF 56 contains magnetizable particles such as carbonyl iron spheroids of about half (½) to twenty five (25) microns in diameter dispersed in a viscous fluid such as silicon oil or synthetic hydrocarbon oil. The MRF 56 may also contain surfactants, flow modifiers, lubricants, viscosity enhancers, and other additives.

A slip ring assembly 58 is mounted with respect to the MRC 10. The slip ring assembly 58 includes spring-biased brushes 59 and 60, which are operable to communicate electrical current to and from a first ring 62 and a second ring 64, respectively. The first and second rings 62 and 64 are secured to the core 36 and are in electrical communication with the coil 30 though conductors 66 and 66′, respectively. A carrier assembly 68 is provided to secure the brushes 59 and 60 with respect to a power steering pump housing 70. The brushes 59 and 60 are in electrical communication with the electrical system of the vehicle and are provided with operating signals from a conventional electronic control module (ECU), not shown. The ECU preferably includes a programmable digital computer that contains stored data for establishing the operational criteria of the MRC 10 during operation of the vehicle.

An inner rotor or output member 72 includes a non-magnetic drive portion 74 secured to the drive shaft 14 through an interference fit or other method. A conventional fastener 76, such as a hex head bolt, is employed to fixedly retain the output member 72 in relation to the drive shaft 14. A non-magnetic hub portion 78 extends generally radially from the drive portion 74, while a substantially cylindrical magnetically permeable drum portion 80 extends generally axially from the hub portion 78. The magnetically permeable drum portion 80 bisects the working gap 46, thereby creating a first working gap 46A and a second working gap 46B. The drum portion 80 has a first surface 82 and a second surface 84 in contact with MRF 56 contained within the working gaps 46A and 46B, respectively. The drum portion 80 has a low magnetic permeability portion 86 to ensure that the magnetic flux field 48 of the core 36 is properly distributed through the working gaps 46A and 46B. The core 36, the magnetically permeable ring 20, the drum portion 80, and the MRF 56 disposed within the working gaps 46A and 46B form the magnetic circuitry of the MRC 10. The dual working gap geometry of the MRC 10 is suited to reduce the axial length of the MRC 10, thereby minimizing the cantilevered loading on the driveshaft 14. The first surface 82 and second surface 84 may have a roughness to reduce the surface sliding friction of the MRF 56, thereby increasing the shear forces of the MRF 56 on the drum portion 80.

The first cover member 22 and the core 36 cooperate to form a storage cavity 88 for the MRF 56 that recedes from the working gap 46 when the MRC 10 is idle. The first cover member 22 has an inner cavity 90 that is a portion of the storage cavity 88. The inner cavity 90 has a wall 92 that diverges toward the working gap 46. Centrifugal forces acting on the MRF 56 in the inner cavity 90 promote the return of the MRF 56 to the working gap 46 during operation of the MRC 10.

The first cover member 22 and the core 66 are rotatably supported on the output member 74 by bearings 94 and 96, respectively. The bearings 94 and 96 are preferably ball-type or roller-type bearings. Labyrinth seals 98 and 100 have tight radial clearances that cooperate with the high viscosity of the MRF 56 to substantially prevent the MRF 56 from reaching the roller bearings 94 and 96, respectively. Disposed within the labyrinth seals 98 and 100 are annular bushings 102 and 104, respectively. The bushings 102 and 104 have a generally C-shaped cross section that closely matches the dimensions of the labyrinth seals 98 and 100, respectively. The bushings 102 and 104 are preferably made from a low friction material such as a carbon based material, or may be made from polytetrafluoroethylene (PTFE) or other suitable polymer. The bushings 102 and 104 operate to reduce the need for precise machining and assembly tolerances of the labyrinth seals 98 and 100 by providing a predetermined amount of sacrificial material, which will be removed through wear during the operation of the MRC 10.

A generally radially extending annular lip 106 is provided on the first cover member 22 and a partially radially and partially axially extending annular lip 108 is provided on the hub portion 78 forming pockets 110 and 112, respectively. The pocket 110 is formed at the inner radial boundary of the storage cavity 88. The pockets 110 and 112 operate to capture and redirect MRF 56 that may recede from the working gap 46B; thereby, preventing MRF 56 from migrating to the labyrinth seal 98 when the MRC 10 is at rest or idle. By redirecting the MRF 56 away from the labyrinth seal 98, the likelihood of exposing the bearing 94 to MRF 56 is minimized. Additionally, a generally radially extending annular lip 114 is provided on the hub portion 78 forming a pocket 116 thereon. The pocket 116 is operable to capture MRF 56 that may recede from the working gap 46A to prevent MRF 56 from migrating to the labyrinth seal 100 and possibly the bearing 96 when the MRC 10 is idle. The pockets 110 and 112 operate to extend the life of the MRC 10 by preventing incursion of MRF 56 within the bearings 94. Likewise, pocket 116 operates to extend the life of the MRC 10 by preventing incursion of MRF 56 within the bearings 96. While the bearings 94 and 96 are sealed units, it is preferred to maintain the MRF 56 out of contact with the bearing seals. Those skilled in the art will recognize that the annular lip 106 may be separate piece attached to the first cover member and may be formed from various non-magnetic materials such as rubbers or polymers. Likewise, the annular lips 108 and 114 may be separate pieces attached to the first cover member and may be formed from various non-magnetic materials such as rubbers or polymers.

A toothed wheel 118 is secured to the drive shaft 14 and cooperates with a sensor 120 to provide the ECU, not shown, with a rotational speed value of the power steering pump 16. The preferred sensor 120 is a Hall Effect sensor; however, those skilled in the art will recognize that other types of sensors may be employed.

During operation, the coil 40 is selectively and variably energized with electrical current, thereby creating the magnetic flux field 48 that passes through the MRF 56 contained within the working gap 46. As is well known, when the MRF 56 is exposed to the magnetic flux field 48, the magnetizable particles therein will align with the magnetic flux field 48 and increase the viscosity of the MRF 56. The increased viscosity will therefore increase the shear strength of the MRF 56 resulting in torque transfer from the input assembly 12 to the output member 72 causing rotation of the drive shaft 14, which operates the power steering pump 16. The torque transfer ability or characteristic of the MRF 56 varies with the intensity of the magnetic flux field 48.

Although the description has detailed the MRC 10 application within a power steering system, those skilled in the art will recognize that the present invention may be incorporated into other clutches employing MRF, such as fan clutches. Additionally, while the foregoing description describes an MRC 10 with a rotating coil 40, the invention herein described may be used in a stationary coil-type MRC. While the best modes for carrying out the invention have been described in detail, those familiar with the art to which this invention relates will recognize various alternative designs and embodiments for practicing the invention within the scope of the appended claims.

1. A magneto-rheological coupling comprising:
an input assembly coaxially disposed and spaced from an output member such that a working gap is defined between said input assembly and said output member;
a magneto-rheological fluid at least partially disposed within said working gap, said magneto-rheological fluid having variable viscosity characteristics in the presence of a variable magnetic field;
at least one bearing operable to rotatably mount said input assembly with respect to said output member; and
at least one annular lip being provided with respect to at least one of said input assembly and said output member, said at least one annular lip being operable to direct the flow of said magneto-rheological fluid away from said at least one bearing.

2. The magneto-rheological coupling of claim 1, further comprising:
at least one labyrinth seal operable to substantially restrict the flow of said magneto-rheological fluid from contacting said at least one bearing.

3. The magneto-rheological coupling of claim 2, wherein an annular bushing is disposed within said at least one labyrinth seal, said annular bushing being operable to reduce the clearances of said at least one labyrinth seal.

4. The magneto-rheological coupling of claim 3, wherein said annular bushing is formed from one of a polymeric material and a carbon material.

5. The magneto-rheological coupling of claim 3, wherein said annular bushing has a predetermined amount of sacrificial material operable to be removed from said annular bushing during operation of the magneto-rheological coupling.

6. The magneto-rheological coupling of claim 1, wherein said at least one bearing is sealed and is one of a roller-type and a ball-type bearing.

7. The magneto-rheological coupling of claim 1, wherein said input assembly includes a first cover, said first cover having a first of said at least one annular lip disposed thereon.

8. The magneto-rheological coupling of claim 1, wherein said output member includes a hub portion, said hub portion having a second of said at least one annular lip disposed thereon.

9. A magneto-rheological coupling comprising:
an input assembly coaxially disposed and spaced from an output member such that a working gap is defined between said input assembly and said output member;
a magneto-rheological fluid at least partially disposed within said working gap, said magneto-rheological fluid having variable viscosity characteristics in the presence of a variable magnetic field;
at least one bearing operable to rotatably mount said input assembly with respect to said output member;
a first annular lip being provided with respect to said input assembly;
a second annular lip being provided with respect to said output member; and
wherein said first and second annular lips are operable to direct the flow of said magneto-rheological fluid away from said at least one bearing.

10. The magneto-rheological coupling of claim 9, further comprising:
at least one labyrinth seal operable to substantially restrict the flow of said magneto-rheological fluid from contacting said at least one bearing.

11. The magneto-rheological coupling of claim 10, wherein and annular bushing is disposed within said at least one labyrinth seal, said annular bushing being operable to reduce the clearances of said at least one labyrinth seal.

12. The magneto-rheological coupling of claim 11, wherein said annular bushing is formed from one of a carbon material and a polymeric material.

13. The magneto-rheological coupling of claim 10, wherein said annular bushing has a predetermined amount of sacrificial material operable to be removed from said bushing during operation of the magneto-rheological coupling.

14. A magneto-rheological coupling comprising:
an input assembly coaxially disposed and spaced from an output member such that a working gap is defined between said input assembly and said output member;
a magneto-rheological fluid at least partially disposed within said working gap, said magneto-rheological fluid having variable viscosity characteristics in the presence of a variable magnetic field;
at least one bearing operable to rotatably mount said input assembly with respect to said output member;
at least one labyrinth seal operable to substantially restrict the flow of said magneto-rheological fluid from contacting said at least one bearing; and
at least one annular bushing disposed within said at least one labyrinth seal, said bushing being operable to reduce clearances of said at least one labyrinth seal.

15. The magneto-rheological coupling of claim 14, wherein said at least one annular bushing is formed from one of a carbon material and a polymeric material.

16. The magneto-rheological coupling of claim 14, wherein said at least one annular bushing has a predetermined amount of sacrificial material operable to be removed from said at least one annular bushing during operation of the magneto-rheological coupling.

17. The magneto-rheological coupling of claim 14, further comprising at least one annular lip being provided with respect to at least one of said input assembly and said output member, said at least one annular lip being operable to direct the flow of said magneto-rheological fluid away from said at least one bearing.
